(19) United States
(12) Patent Application Publication
(10) Pub. No.: US 2025/0024000 A1
(43) Pub. Date: Jan. 16, 2025

(54) DATA RECORDING METHOD, DEVICE AND SYSTEM FOR VIRTUAL PRODUCTION

(71) Applicant: VIVE STUDIOS CO., LTD, Seoul (KR)

(72) Inventor: Sung Su KIM, Seongnam-si (KR)

(21) Appl. No.: 18/901,500

(22) Filed: Sep. 30, 2024

Related U.S. Application Data
(63) Continuation of application No. PCT/KR2023/004143, filed on Mar. 29, 2023.

(30) Foreign Application Priority Data
Jun. 2, 2022 (KR) 10-2022-0067480

(51) Int. Cl. H04N 5/222; H04N 5/265; H04N 5/77; H04N 5/775; H04N 5/91

(52) U.S. Cl. CPC H04N 5/2224; H04N 5/265; H04N 5/77; H04N 5/775; H04N 5/91

(57) ABSTRACT

A data recording method, device and system for virtual production are provided. The device according to one embodiment of the present invention comprises: a communication unit for receiving first tracking data comprising tracking information about the movement and lens state of a camera capturing a first image, which is a real image; and a control unit using the first tracking data so as to control that recording data, which includes second tracking data comprising tracking information about the movement and lens state of a virtual camera in a virtual space, is stored, wherein the control unit uses the recording data so as to control that a second image, which comprises content of the virtual space linked on the basis of the second tracking data, is played back.

### CROSS-REFERENCE TO RELATED APPLICATIONS

This application is a continuation of International Application No. PCT/KR2023/004143, filed Mar. 29, 2023, which claims priority to South Korean Application No. 10-2022-0067480, filed Jun. 2, 2022, the contents of which applications are incorporated into the present application by reference.

### 1. TECHNICAL FIELD

The present invention relates to data recording and playing back technology in image capturing, and more particularly, to technology for recording tracking data and the like in virtual production-based image capturing and using the recorded data.

### 2. RELATED ART

Recently, as movement between countries and gatherings of people have been restricted due to the coronavirus, interest in non-face-to-face technology based on virtual reality is growing. According to this trend, attempts to introduce virtual production technology in the field of video production, such as broadcasting, movie, and performance, have been increasing.

In this case, the virtual production is an image capturing technology that may instantaneously visualize and synthesize images based on real-time rendering computer graphics (CG) technology, which is content of a virtual space generated by a game engine, and camera tracking technology that reflects camera movement and lens state. For example, the virtual production may be used as a concept of visualizing CG reflecting the movement and lens state of the camera in various forms in image capturing site, and synthesizing it with a real image of the camera in real time.

This virtual production may be mainly performed indoors to reduce restrictions on capturing space, time, and weather, and since complex elements may be captured simultaneously, the time of post-production stage of image production may be reduced, thereby improving productivity of image production.

Meanwhile, in the post-production stage of virtual production, real-time graphic CG is corrected, and accordingly, there is frequently a situation in which real-time graphic CG states based on tracking data at the time of capturing should be played back as it is. In this case, tracking data (hereinafter, referred to as “first tracking data”) reflecting the movement and lens state of the camera at the time of capturing may be acquired through a tracking device installed in an actual camera that performs optical capturing.

However, tracking data (hereinafter, referred to as “second tracking data”) reflecting the movement and lens state of a virtual camera located in a virtual space, such as game engines, so as to generate real-time rendering CG in conjunction with the first tracking data at the time of capturing is a completely different type of data from the first tracking data.

In particular, in the case of the second tracking data, the virtual camera corresponds to data reflecting the movement and lens state of the virtual camera relative to a reference position in the virtual space, and the reference position of the virtual camera in the virtual space may be randomly changed to various positions in the virtual space during capturing in response to a request of a supervisor or the like at the time of capturing.

That is, in the correction of the post-production stage, the second tracking data is substantially needed to play back the real-time graphic CG state at the time of capturing. However, in the conventional case, since it is generally only recording the first tracking data at the time of capturing, the correction of the post-production stage is virtually impossible, or there is a time and cost problem in which the capturing equipment should be prepared under the same conditions as at the time of capturing in order to derive the second tracking data from the first tracking data in the post-production stage (hereinafter, referred to as “first problem”).

On the other hand, when capturing a virtual production, an image captured by an actual camera at a special time point (hereinafter referred to as a “first image”), second tracking data of a real-time rendering CG (hereinafter referred to as a “second image”) generated by conjunction with the first tracking data on the movement and lens state of the actual camera, and a result image (hereinafter referred to as a “synthesized image”) obtained by synthesizing the first and second images in real time should be recorded and stored, respectively. In this case, when it is necessary to correct a specific part of the second image (hereinafter referred to as an “error part”) in the synthesized image during the post-production stage, the content of the virtual space for the corresponding error part should be corrected, and then the corrected virtual space content should be played back based on the second tracking data at the specific time point and synthesized in the first image.

However, in the conventional case, there is a problem in that it is not only possible to identify which second tracking data at the specific time point is among the plurality of recorded second tracking data even if the second tracking data is recorded (hereinafter, referred to as a “second problem”) as well as the first problem due to the difficulty of recording the second tracking data.

However, the above description provides background information about the present invention only and does not correspond to the previously disclosed technology.

### SUMMARY

In order to solve the problems of the conventional technology as described above, the purpose of the present invention is to provide a technology capable of recording second tracking data during capturing a virtual production.

In addition, another purpose of the present invention is to provide a technology capable of playing back a second image reflecting movement and lens state of a virtual camera at the time of capturing in a post-virtual production stage based on second tracking data recorded during capturing a virtual production.

In addition, another purpose of the present invention is to provide a technology capable of recording identification data for second tracking data at a specific time point during capturing a virtual production.

In addition, another purpose of the present invention is to provide a technique capable of playing back a second image reflecting movement and lens state of a virtual camera at a specific time point in a post-virtual production stage based on identification data on second tracking data recorded at a specific time point during capturing a virtual production.

However, the technical problem to be solved by the present invention is not limited to the above-mentioned technical problem, and other technical problems not mentioned may be clearly understood by those skilled in the art to which the present invention pertains from the following description.

The device according to an embodiment of the present invention for solving the above problems includes a communicator configured to receive first tracking data comprising tracking information about the movement and lens state of a camera capturing a first image, which is a real image; and a controller using the first tracking data so as to control that recording data, which includes second tracking data comprising tracking information about the movement and lens state of a virtual camera in a virtual space, is stored.

The controller may control the second image containing content of a virtual space to be played back based on the second tracking data by using the recording data.

The second tracking data may correspond to data on the movement and lens state of the virtual camera linked to the first tracking data at a reference position in the virtual space.

The reference position may be changed to various positions in the virtual space during capturing.

The movement of the virtual camera may include information about position and angle of the virtual camera.

The lens state of the virtual camera may include information about angle of view and focus of the lens of the virtual camera.

The controller may store state data on timeline position and event occurrence of the content of the virtual space together as recording data.

The content of the virtual space may include content that changes depending on the timeline position.

The event occurrence may include appearance, change or disappearance of specific content in the content of the virtual space.

The timeline position and the event occurrence may be set to various states during capturing.

The controller may store data on time code generated by the camera during capturing and data on absolute time during which the capturing is performed.

The controller may control to store the data on the time code using the time code included in each frame of the first image.

The controller may store the data on the absolute time in file of the recording data, and store the data of the time code in metadata on the file of the recording data.

The controller may control to synthesize a second image being played back with the received first image and output a corresponding synthesized image to another device.

The other device may include a recording device.

The controller may control to play back the second image in the form of augmented reality (AR), virtual reality (VR), augmented reality (AR), or extended reality (XR).

The method according to an embodiment of the present invention is performed by an electronic device, and includes receiving first tracking data containing tracking information about movement and lens state of a camera capturing a first image, which is a real image, and playing back a second image containing content of a virtual space linked based on a second tracking data while storing recording data including second tracking data containing tracking information about movement and lens state of a virtual camera in the virtual space using the received first tracking data,

A device according to another embodiment of the present invention includes a memory that stores a plurality of files of recording data including second tracking data containing tracking information about the movement and lens state of the virtual camera in the virtual space; and a controller that controls to select at least one file including recording data on a specific time point at the time of capturing according to a user input.

The controller may control to play back the second image containing content of the virtual space for the specific time point linked based on the second tracking data using second tracking data of the selected file, and the second tracking data may be generated using first tracking data containing tracking information about the movement and lens state of the camera capturing the first image, which is a real image.

A method according to another embodiment of the present invention is performed by an electronic device, and includes among a plurality of files of recording data including second tracking data containing tracking information about the movement and lens state of the virtual camera in the virtual space according to a user input, selecting at least one file including recording data on a specific time point at the time of capturing; and by using the second tracking data of the selected file, playing back the second image containing content of the virtual space for a specific time point linked based on the correspondent second tracking data.

The present invention configured as described above has an advantage in that the second tracking data is recorded during capturing the virtual production or corresponding recording data is utilized, so that the second image reflecting the movement and lens state of the virtual camera at the time of capturing in the post-virtual production stage may be quickly played back at low costs.

In addition, the present invention has an advantage in that the second image reflecting the movement and lens state of the virtual camera at the specific time point can be easily found and played back in the post-virtual production stage by recording data that can be identified from the second tracking data at the specific time point during capturing the virtual production or utilizing the corresponding recording data.

The effects obtained in the present invention are not limited to the effects mentioned above, and other effects not mentioned can be clearly understood by those skilled in the art to which the present invention belongs from the following description.

### BRIEF DESCRIPTION OF THE DRAWINGS

FIG. 1 shows a schematic block diagram of a system 10 according to an embodiment of the present invention.

FIG. 2 shows a conceptual diagram of virtual production capturing using the system 10 according to an embodiment of the present invention.

FIGS. 3 and 4 show examples of movement of a virtual camera VC linked according to movement of the camera 100 during capturing according to FIG. 2.

FIG. 5 shows an example of data recorded in the play-back device 300.

FIG. 6 shows a block configuration of the play-black device 300.

FIG. 7 shows an operation flowchart of the first control method according to an embodiment of the present invention.

FIG. 8 shows an operation flowchart of the second control method according to an embodiment of this invention.

### DETAILED DESCRIPTION OF EXEMPLARY EMBODIMENTS

The above objects, means and advantages of the present disclosure will become more apparent from the following detailed description of the accompanying drawings, and accordingly, those skilled in the art will easily embody the technical idea of the present disclosure. In addition, in the description of the present disclosure, a detailed description of known techniques related to the present disclosure will be omitted when it is determined that the subject matter of the present disclosure may be unnecessarily obscured.

The terminology used herein is for the purpose of describing embodiments and is not intended to limit the present disclosure. In the present specification, the singular forms include the plural forms as well, unless otherwise specified. In the present specification, the terms “comprise”, “include”, “provided with”, and “have” do not exclude the presence or addition of one or more other components other than the mentioned components.

In the present specification, the terms “or”, “at least one”, and the like may indicate one of the words listed together, or may indicate a combination of two or more. For example, “A or B”, “at least one of A and B” may include only one of A or B, and may include both A and B.

In the description according to “for example”, and the like, the presented information such as the characteristics, variables, or values mentioned may not be exactly consistent, and the embodiments of the present disclosure according to various embodiments of the present disclosure should not be limited by effects such as variations including tolerances, measurement errors, limitations of measurement accuracy, and other commonly known factors.

In the present specification, when an element is described as being “connected to” or “coupled with” another element, it should be understood that the element may be directly connected to or connected to the other element, but other elements may be present in the middle. On the other hand, when an element is described as being “directly connected to” or “directly coupled with” another element, it should be understood that there are no intervening elements.

In the present specification, when an element is described as being “over” or “on top of” another element, it should be understood that the element may be directly engaged or connected to the other element, but other elements may be present in the middle. On the other hand, when an element is described as being “directly on” or “in contact with” another element, it should be understood that there are no intervening elements. Other expressions for describing a relationship between elements, for example, “between” and “directly between” may be interpreted as well.

In the present specification, the terms “first”, “second”, and the like may be used to describe various elements, but the elements should not be limited by the above terms. In addition, the above terms should not be interpreted as being used to limit the order of each element, but may be used to distinguish one element from another. For example, the first component may be referred to as the second component, and similarly, the second component may be referred to as the first component.

Unless otherwise defined, all terms used in the specification may be used in their meanings that can be commonly understood by those skilled in the art to which the present disclosure pertains. Further, terms defined in a commonly used dictionary are not interpreted ideally or excessively unless otherwise clearly defined.

Hereinafter, preferred embodiments of the present invention will be described in detail with reference to the accompanying drawings.

First, to understand the present invention, virtual production technology is examined from two different perspectives.

### 1. Viewpoints of Stage of Image Production

Generally, the real-time graphic rendering technology, referred to as a game engine, has recently been evolved enough to show the photo-realistic quality. Such immediate and high-quality visualization technology may be used for different purposes at various points in the image production pipeline, which are divided into a pre-planning stage, a production stage, and a post-production stage.

First, in the pre-planning stage, the game engine may be actively used for story visualization (Pre Vis) or space/equipment simulation (Tech Vis). In other words, in the planning stage, not only the development of contents but also space, camera movement, cut editing, etc. are implemented in advance and various issues (set size, movement line, lens angle of view, etc.) are checked in advance. Especially, in recent years, the use of virtual reality technology has been increasing, such as editing components in a virtual environment or simulating capturing with a virtual camera through VR Scouting technique centered on movies.

Next, in the production stage, the virtual production technology is used in a form that simultaneously performs capturing and synthesizing CG (computer graphics), which done in the post-production stage and transmits it in live or reduces the burden of post-production synthesized. To this end, an XR solution that synthesizes real image and CG in real time is used along with a tracking device that detects the movement of the camera.

Finally, in the post-production stage, state data such as tracking data generated during capturing may be used. Using this, additional effects or CG (Computer Graphics) elements may be generated even after capturing is finished, and scenes that have problems or need correction may be corrected more quickly.

### 2. Viewpoints of Method for CG Synthesized

The core of virtual production technology is a visualization function that synchronizes real space and virtual space to synthesize the CG and real image in real time without any sense of heterogeneity or display them on LED (Light Emitting Diode) walls. Therefore, terms such as virtual reality (VR), augmented reality (AR), and extended reality (XR) may be used depending on the type in which CG is synthesized.

First, VR refers to real-time spatial synthesized based on Chroma key studio. For example, a VR-based virtual production technology may be used to simultaneously show a person and a virtual space in the third person. That is, it is possible to obtain the same effect as directly capturing in virtual reality through a camera with real-time tracking. The reason why such a production is possible is that an image in which the virtual space is synthesized is generated in real time and is provided to a camera supervisor and a director to enable immediate judgment and correspondence.

In the case of AR, it refers to a method of adding a specific graphic on a real image in contrast to VR, and recently, it is widely used for events such as broadcasting, performance, and product launching show. In particular, with the development of rendering technology such as Realtime Ray Tracing and DLSS, the CG quality of game engines is gradually approaching the real image, and attempts to express scenes that are difficult to physically implement or expensive production with AR graphics, are increasing. For example, by adding AR elements to an image that has only one car in the actual stage space, a special production such as a new car emerging from the floor or a new building being created are possible.

In the case of XR, non-face-to-face events have been used in earnest since 2020. Unlike AR or VR, XR can be expressed as if it were completely in a virtual space by synthesizing both far scene and near scene into CG. To this end, the LED wall body may be disposed on the background to output a far scene, add AR graphics to the front of the subject to express a sense of space, and expand the outside of the physical boundary of the LED wall to CG to express it as if it is in an infinite space.

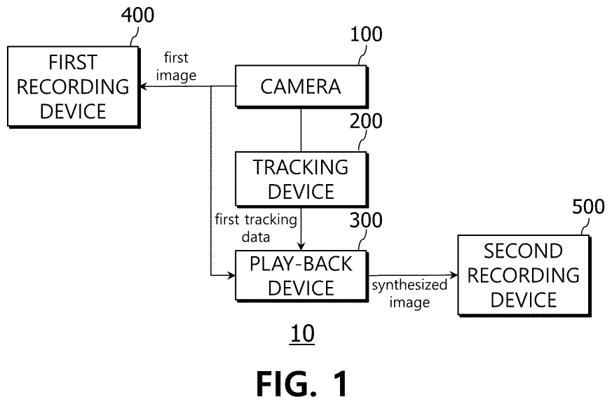

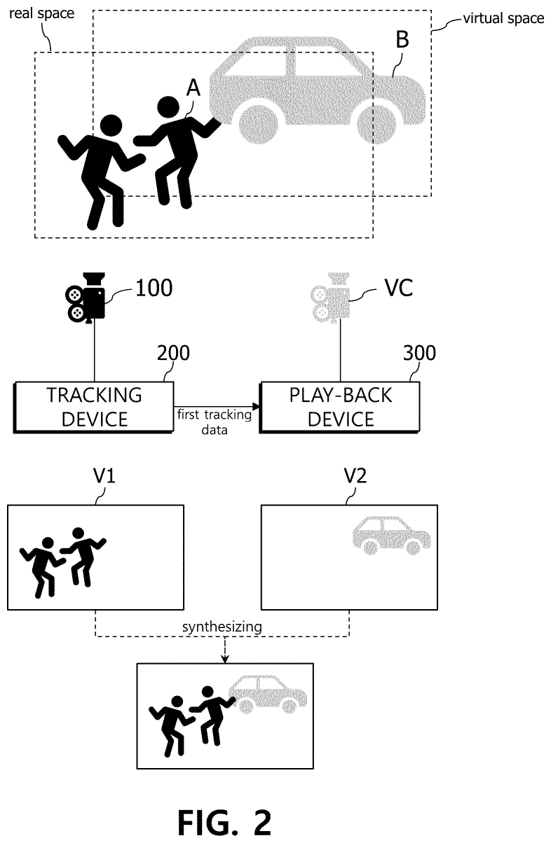

FIG. 1 shows a schematic block diagram of a system 10 according to an embodiment of the present invention, and FIG. 2 shows a conceptual diagram of virtual production capturing using the system 10 according to an embodiment of the present invention.

The system 10 (hereinafter referred to as a “this system”) according to an embodiment of this invention is a system utilized in the virtual production described above, and as shown in FIG. 1, may include a camera 100, a tracking device 200, and a play-back device 300. In addition, this system 10 may further include first and second recording devices 400.

At this time, the camera 100 captures a first image, which is a real image, by optical action on an object (A) existing in the actual space (physical space). As necessary, the camera 100 may be provided in plural. For example, the first image may be a video in which various images change over time. As such, the real image captured by the camera 100, the first image may be transmitted to the first recording device 400 and recorded.

The tracking device 200 is a device installed (connected) to the camera 100 and tracks the movement and lens status of the camera 100 to generate first tracking data, which is data for the corresponding tracking. In this case, the data on the movement of the camera 100 included in the first tracking data includes data related to the position and angle of the camera 100. In addition, the data on the lens state included in the first tracking data includes data related to the zoom and focus of the lens of the camera 100.

For example, the tracking device 200 may be implemented using an optical method based on real-time vision sensing, or an encoder method that calculates by combining rotation values of a machine. This tracking device 200 has a manufacturer-specific transport protocol and transmits first tracking data including data on the position and angle of the camera 100, and lens state (zoom and focus) using a UDP-based public protocol called FreeD.

That is, referring to FIG. 2, a first image V1, which is a real image, is captured through a camera 100, and at this time, a tracking device 200 generates first tracking data on the movement and lens state of the camera 100, and the generated first tracking data is transmitted to a play-back device 300. Of course, between the tracking device 200 and the play-back device 300, a server (not shown) that receives the first tracking data from the tracking device 200 and transmit s the first tracking data to the play-back device 300 may be included. Thereafter, the play-back device 300 plays back a second image V2 including content B of a virtual space that is interlinked on the base of the received first tracking data.

At this time, the content B of the virtual space is real-time rendering computer graphics (CG) generated by a game engine, and corresponds to content that may be changed in conjunction with the first tracking data that tracks the movement and lens state of the camera 100. For example, the content of the virtual space may be CG for VR or XR, and may be media produced by an Unreal Engine, but is not limited thereto.

That is, the content B of the virtual space is CG content that is prepared in advance in the above-described pre-planning step, and corresponds to a portion captured (acquired) by a virtual camera VC in a virtual space having the three-dimensional virtual content. At this time, the play-back device 300 may generate and play back the second image V2 by allowing the virtual camera VC to capture the content B of the corresponding virtual space while the movement and lens state are changed based on linkage with the first tracking data at a reference position within the virtual space.

More specifically, the play-back device 300 may generate second tracking data to be described later based on the first tracking data, and generate and play back the second image V2 including content B of the virtual space that is linked on the base of the corresponding second tracking data. For example, the second image V2 may be played back in the form of augmented reality AR, and may be a video in which various images are changed over time.

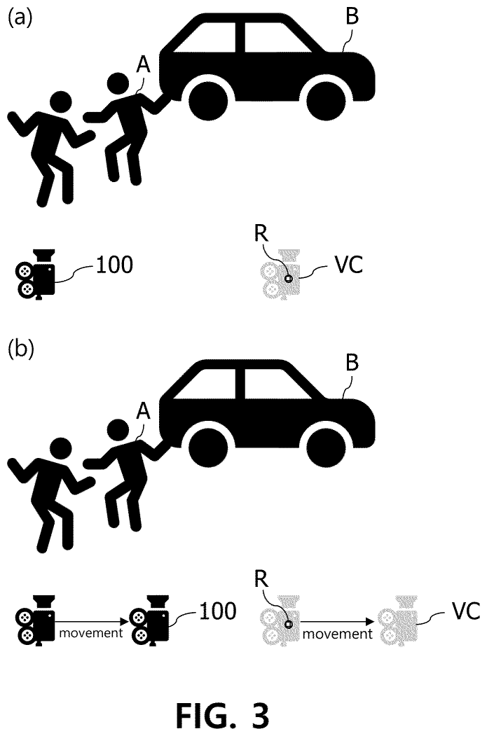

FIGS. 3 and 4 show examples of movement of a virtual camera VC linked according to the movement of the camera 100 during capturing according to FIG. 2. However, FIG. 4 shows a case where the reference position R is changed in FIG. 3.

That is, the second image V2 played back in the play-back device 300 includes content of the virtual space that reflects the movement and lens state of the camera 100. For example, as shown in FIGS. 3 and 4, when the camera 100 moves from a first position to a second position, the virtual camera VC may also reflect the change in the position based on the reference point R, and the content B of the virtual space may be captured and included in the second image V2.

Meanwhile, the play-back device 300 is an electronic device capable of computing, stores information for real-time rendering CG (computer graphics), and generates and plays back the second image linked to the first tracking data. For example, the play-back device 300 may be a player that causes the second image to be played back in an AR form.

For example, the play-back device 300 may be a desktop personal computer, a laptop personal computer, a tablet personal computer, a netbook computer, a workstation, a smartphone, a smart pad, a mobile phone, a media play-back device, or the like, but is not limited thereto.

On the other hand, in the post-production of virtual production, real-time graphic CG is corrected, and accordingly, there is frequently a situation in which real-time graphic CG states based on tracking data at the time of capturing should be played back as it is. However, since it is difficult to play back the second image including the content of the virtual space at the time of capturing with the first tracking data alone, it is virtually impossible to correct the post-production stage, or there is a time and cost problem in which the capturing equipment should be prepared under the same conditions as at the time of capturing in order to derive the second tracking data from the first tracking data in the post-production stage.

That is, the play-back device 300 may receive the FreeD-type first tracking data generated at a specific time point from the tracking device 200 and record it as it is. However, it is difficult to reconstruct the condition at the corresponding time point perfectly when the rendering is necessary again in the post-production stage with only the first tracking data. Therefore, when recording only the first tracking data, the meaning is only to store backup data in preparation for the worst situation, but it is difficult to actually use the first tracking data usefully in the post-production stage. The reasons are as follows.
(1) The value of the first tracking data is only raw data sent by the tracking device 200.

Basically, the FreeD protocol includes information on the lens state such as the zoom position, focus position, and aperture position of the lens, in addition to the position and angle of the camera 100. In this case, the numerical value indicating the lens state does not indicate the actual angle of view and the physical distance of the focus of the lens, but means the position value of the rotation ring output by the encoder device attached to the lens. Therefore, when actually capturing, the lens data is converted into meaningful information (angle of view and distance) using the lens file in which the mapping information of the data is recorded, and then applied to the virtual camera VC of the game engine. At this time, when capturing on-site, commercial synthesizing programs (Zero Density, Pixotope) that provide numerical conversion through lens files are used, so the first tracking data of the FreeD method may be used without problems. However, when re-rendering is required in the post-production stage, it is difficult to apply because there is no corresponding lens file and even if there is a lens file, it is a dedicated format of a company. That is, even if there is a file in which the first tracking data based on FreeD is recorded, it is helpful enough to check the position or angle of the camera 100, but since it does not include the lens state at the time of capturing or the content state of the virtual space, the utility becomes very low.
(2) It is difficult to play back the content of the virtual space at the corresponding time point with only the data on the movement and the lens state of the camera 100 included in the first tracking data.

As described above, the first tracking data transmitted according to the FreeD method includes the position and angle of the camera, lens zoom, lens focus value, and the like in the form of raw data provided by the tracking device 200. When the CG content of the virtual space is played back again with only such data, regardless of details of the content, it is possible to play back only the degree to which the virtual camera VC moves in real time to the position of the recorded first tracking data. In other words, if the content state (timeline location, event that occurred) of the virtual space at the corresponding time point is not known, it is difficult to play back the content substantially with the same production.

To solve such a problem, in this invention, the play-back device 300 records and stores second tracking data, which is the tracking data for the movement and lens state of the virtual camera VC in the virtual space at the time of capturing. Of course, the play-back device 300 may also record and store the first tracking data along with the second tracking data.

That is, while performing play-back of the second image, the play-back device 300 records and stores the second tracking data of the virtual camera VC for the second image to be played back using the first tracking data transmitted from the tracking device 200.

In this case, the second tracking data is the tracking data reflecting the movement and lens state of the virtual camera VC located in the virtual space so as to capture (acquire) the second image in conjunction with the first tracking data. However, the second tracking data is a kind of data that is linked to the first tracking data but is completely different from the first tracking data.

That is, the data for the movement of the virtual camera VC included in the second tracking data includes data related to the position and angle of the virtual camera VC. In addition, the data for the lens state included in the second tracking data includes data related to the aperture and focus, and the like of the lens of the virtual camera VC.

In particular, as shown in FIGS. 3 and 4, the second tracking data corresponds to the data for the movement and lens state of the virtual camera VC linked to the first tracking data at the reference position R of the virtual camera VC in the virtual space. The reference position R of the virtual camera VC in the virtual space is not continuously fixed during capturing, and may be arbitrarily changed according to a request such as supervisor according to a scene at the time of capturing.

In this case, the second tracking data corresponds to the tracking data of the virtual camera VC in the virtual space reflecting the changed reference position R, so if the second tracking data is used in the post-production stage, the second image reflecting the arbitrary change in the reference position R of the virtual camera VC may be played back.

A more specific reason to utilize this second tracking data is as follows.

<Because the Final Interpreted Information, Rather than the Raw Information of the First Tracking Data According to the FreeD Method, Must be Recorded in Real Time>

When actually capturing, the raw information included in the first tracking data according to the FreeD method is not information that is finally used for rendering the content of the virtual space. That is, the play-back device 300 may render the content of the virtual space only when the value derived by interpreting or correcting the information included in the first tracking data transmitted in the FreeD method is transmitted to the game engine or the like.

That is, since the data related to the movement (position and angle) of the camera 100 in the first tracking data is a value based on the unique center point of the tracking device 200, the play-back device 300 sets a correction value as much as desired to position the virtual camera VC in the virtual space. Therefore, the second tracking data including the position and angle values of the virtual camera VC in the game engine to which the correction value is applied must be finally recorded.

Likewise, in the case of the data related to the lens state (zoom and focus distance) in the first tracking data, the data is simply the numerical value of the tracking device 200, so after interpreting this, the value of the angle of view FOV and focus distance applied to the virtual camera VC of the actual game engine is recorded, so that they may be effectively used in the post-production stage.

The play-back device 300 may record and store the second tracking data over time and also the state (i.e., timeline position, occurrence of the event, and the like) of the content of the virtual space at each time point.

That is, the real-time rendering CG (i.e., content of the virtual space) played back on the play-back device 300 includes content that variously changes depending on the position of a pre-prepared timeline. The timeline position for the content of the virtual space may be changed over time or fixed to a specific position by an instruction of the supervisor during capturing.

For example, the content B of the virtual space shown in FIG. 2 is a “car”, and the timeline for the corresponding car may be 5 seconds. At this time, the corresponding car may be stationary in the timeline of zero to 1 second, slowly move in one direction in the timeline of 1 to 3 seconds, and rapidly move in the timeline of 3 to 5 seconds, and disappear in the virtual space.

The play-back device 300 may generate a pre-defined specific event with respect to the content of the virtual space during capturing. For example, the event with respect to the content of the virtual space may be an appearance, a change, or a disappearance of the specific content, etc. That is, unlike general images, since the playback device 300 is developed based on a real-time rendering method unlike a general image and has a character capable of freely adjusting its state at a desired time point similar to a game, event occurrence for content of the virtual space may be used to give diversity to the second image state.

For example, if rain or lightning effects are pre-defined in the virtual space, the play-back device 300 may generate the corresponding event at a specific time point during capturing according to an instruction of the supervisor.

The content state (i.e., the timeline position and event occurrence) of the virtual space may be set to various multiple states by a supervisor′ indication during capturing. At this time, the play-back device 300 records and stores the data on the timeline position for the content of the virtual space and the event occurrence at a specific time point (i.e., the state data on the content of the virtual space) together with the second tracking data. Accordingly, in the post-production stage, the second tracking data and the corresponding state data may play back the state of the content at each time point at the time when the capturing is properly performed.

A more specific reason for using the state data for content of the virtual space is as follows.

Since the first tracking data according to FreeD includes only information about the movement and lens state of the camera 100, it is impossible to know what scene actually displayed back in the content of the virtual space at the time of capturing using only the first tracking data. To this end, the real-time progress state of the timeline for the content of the corresponding virtual space should be known. In addition, if the operator irregularly generates an interaction effect (e.g., explosion) event during capturing, the corresponding information should be recorded inside the recording file, so that the content of the virtual space may be played back under the same conditions in the post-production stage.

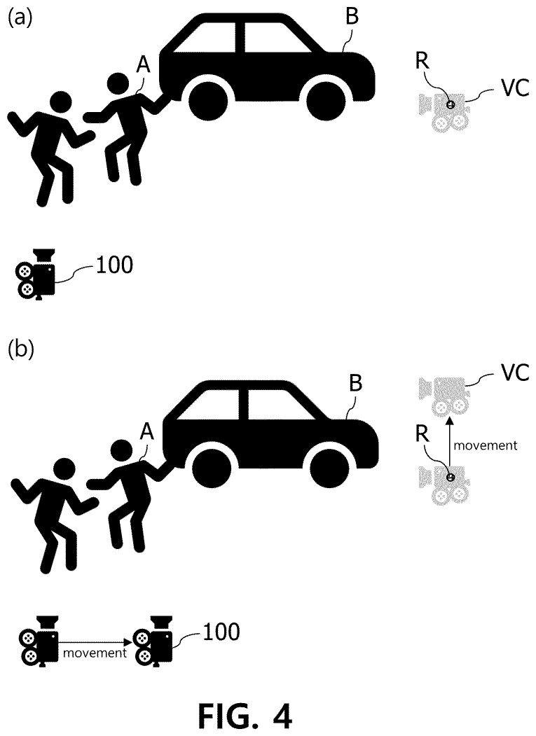

FIG. 5 shows an example of data recorded in the play-back device 300.

That is, the data recorded by the play-back device 300 (hereinafter referred to as “recording data”) includes second tracking data for the virtual camera VC and state data for the content of the virtual space, and may be stored in multiple files (i.e., recording data files) during capturing.

For example, referring to FIG. 5, the data on the movement of the virtual camera VC included in the second tracking data includes position data for the virtual camera VC such as Pos x (x-axis value of the virtual space), Pos y (y-axis value of the virtual space), and Pos z (z-axis value of the virtual space), and angle data for the virtual camera VC such as Rot x (angle to the x-axis of the virtual space), Rot y (angle to the y-axis of the virtual space), and Rot z (angle to the z-axis of the virtual space). In addition, the data on the lens state included in the second tracking data includes angle of view data on the lens of the virtual camera VC, such as the aperture, and focus data on the lens of the virtual camera VC, such as the focal length and the focal distance. In addition, the state data on the content of the virtual space included in the recording data may include the timeline position and whether the timeline is played back, and although not shown in FIG. 5, the data on the event occurrence may also be included.

Meanwhile, the play-back device 300 receives the first image captured by the camera 100 and outputs a result image (hereinafter referred to as “synthesized image”) obtained by synthesizing the second image being played back in the first image. As described above, the synthesized image output from the play-back device 300 may be transmitted to a second recording device 500 and recorded.

In addition, in the post-production stage, it is necessary to correct for a specific part (i.e., an error part) of the second image in the synthesized image. In this case, after correcting the content of the virtual space for the corresponding error part, the corrected content of the virtual space may be played back based on the recording data at a specific time point and synthesized again in the first image, thereby generating the corrected synthesized image.

At this time, in order to play back the corrected content of the virtual space based on the recording data at the specific time point, it is necessary to identify which is the recording data at the specific time point among the recording data stored by the play-back device 300. To solve such problem, the play-back device 300 may additionally store identification data as the recording data.

This identification data may include data on a time code, which is information on the time generated by the camera 100 during capturing, and data on an absolute time, which is information on the absolute time that the corresponding capturing was performed. That is, in the capturing site, the camera 100 is connected to a device for generating a time code changed according to time (i.e., time code generation device) (not shown), and generates information on the first image in which the corresponding time code is included in each frame during capturing. At this time, the play-back device 300 identifies the same time code as the time code transmitted to the camera 100 from the first image of the camera 100, and records and stores the corresponding time code data as identification data.

However, the play-back device 300 may not record the time code data in a recording data file (e.g., a file storing the details as shown in FIG. 5) including the state data on the second tracking data and the contents of the virtual space, but store the corresponding time code data in a metadata file that stores the metadata on the recording data file.

In addition, the play-back device 300 may measure the time after the recording data file starts to be recorded during capturing by zero, measures the subsequent time sequentially, and records the absolute time data, which is the time for the recording data file, as recording data together with the state data on the second tracking data and the content of the virtual space. Alternatively, the play-back device 300 may record the absolute time data on the real-time time during capturing as the recording data together with the state data on the second tracking data and the content of the virtual space. For example, in FIG. 5, the term “progress time” indicates this absolute time data.

A more specific reason for utilizing the identification data is as follows.

### <Difficulty Finding Original Image Corresponding to the Part of the Recorded First Tracking Data>

In the case of the FreeD-based first tracking data, since it is not a concept that includes time, the “absolute time” is not included during recording, and it is generally recorded by one packet according to a designated frame. However, it may be quite difficult to find the original captured image mapped to it with the recorded data for the post-production stage. In the case of the FreeD-based first tracking data, since it is a file formed of a series of raw data, it is not easy to find a desired part of the vast recorded image based on this.

### <Time Code Value and Absolute Time Generated by the Camera (100) are Recorded as Metadata to Facilitate Search for Recorded Images>

It is difficult to find the recorded image corresponding to the time point with only the FreeD-based first tracking data, which is a combination of vast numbers. Therefore, in this invention, the absolute time during which the corresponding capturing was performed and the time code of the camera 100 are separately recorded. Through this, it is possible to quickly search for when the recording file was recorded by comparing it with the time code recorded in the actual recorded video.

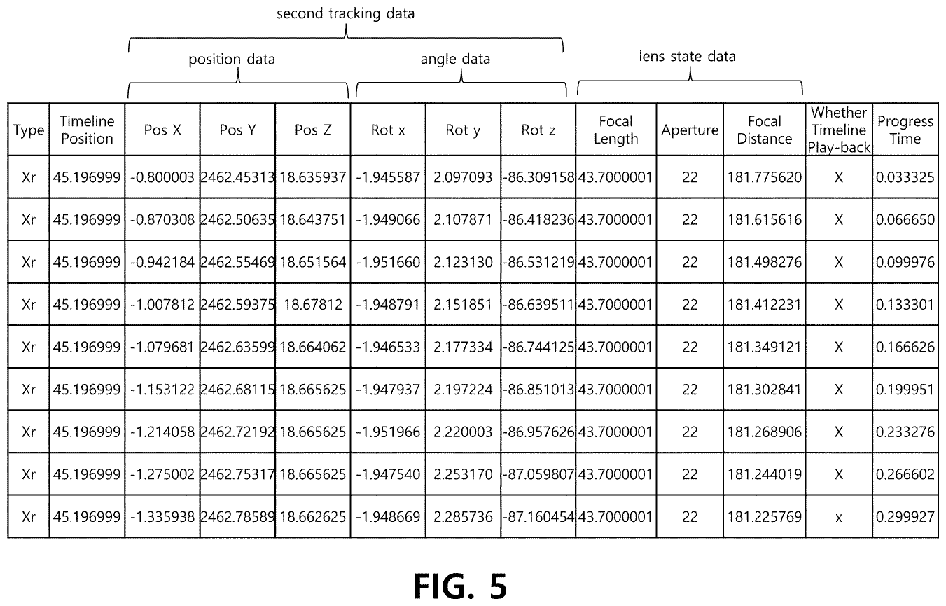

FIG. 6 shows a block configuration of the play-black device 300.

The play-back device 300, as shown in FIG. 6, may include an input unit 310, a communicator 320, a displayer 330, a memory 340, and a controller 350.

The input unit 310 generates input data in response to various user inputs and may include various input means. For example, the input unit 310 may include a keyboard, a key pad, a dome switch, a touch panel, a touch key, a touch pad, a mouse, a menu button, and the like, but is not limited thereto.

The communicator 320 is a component that performs communication with other devices. For example, the communicator 320 may receive the first tracking data from the tracking device or server through the protocol of FreeD. For example, the communicator 320 may perform wireless communication such as 5th generation communication (5G), long term evolution-advanced (LTE-A), long term evolution (LTE), Bluetooth, Bluetooth low energy (BLE), near field communication (NFC), and WiFi communication, or may perform wired communication such as cable communication, but is not limited thereto.

The displayer 330 displays various image data on a screen, and may be composed of a non-emissive panel or an emissive panel. For example, the display 330 may display the first image, second image, or synthesized image. For example, the displayer 330 may include a liquid crystal display (LCD), a light emitting diode (LED) display, an organic LED (OLED) display, a micro electromechanical systems (MEMS) display, or an electronic paper display, but is not limited thereto. In addition, the displayer 330 may be combined with the input unit 310 and implemented as a touch screen or the like.

The memory 340 stores various kinds of information necessary for the operation of the play-back device 300. For example, the storage information of the memory 340 may include information on the first image, first tracking data, real-time rendering CG, recording data, identification data, second image, synthesized image, control program, and the information related to the control method to be described later, but is not limited thereto.

For example, the memory 340 may include, but is not limited to, a hard disk type, magnetic media type, compact disc read only memory (CD-ROM), optical media type, magneto-optical media type, multimedia card micro type, flash memory type, read only memory type, or random access memory type, depending on its type. In addition, the memory 340 may be a cache, buffer, main storage device, or auxiliary storage device or a separately provided storage system depending on its purpose/location, but is not limited thereto.

The controller 350 may perform various control operations of the play-back device 300. That is, the controller 350 may control recording and storage of the above-described recording data and identification data, and may control execution of the control program stored in the memory 340 and the control method to be described later. In addition, the controller 350 may control operations of the remaining components of the play-back device 300, that is, the input unit 310, communicator 320, displayer 330, and memory 340, and the like. For example, the controller 350 may include at least one processor that is hardware, and may include a process that is software performed on the corresponding processor, but is not limited thereto.

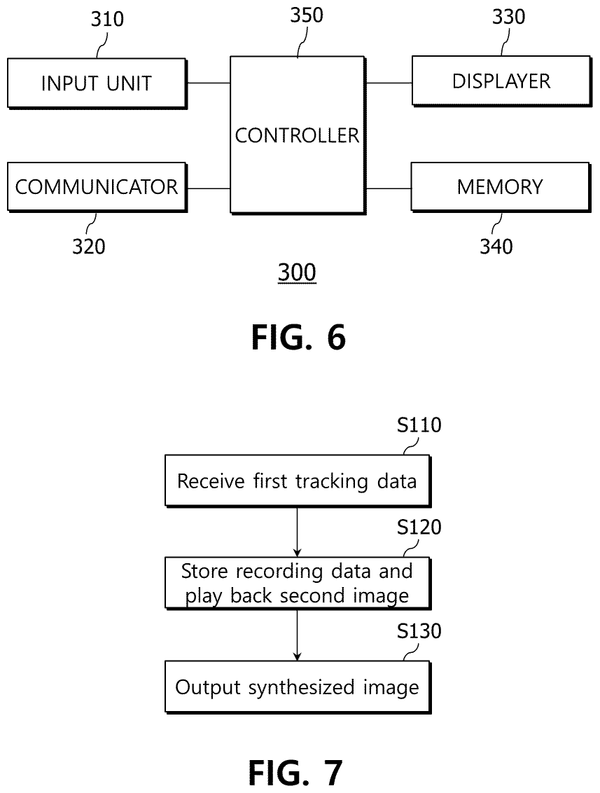

FIG. 7 shows an operation flowchart of the first control method according to an embodiment of this invention.

The first control method according to an embodiment of this invention is performed during capturing, and the operations may be controlled by the controller 350 of the play-back device 300, and as shown in FIG. 7, includes step S110 to S130. However, only step S110 and S120 may be essential operations, and step S130 may be optional operation applied to the case where the second image is played back in the form of AR.

In step S110, the controller 350 controls to receive first tracking data that tracks the movement and lens state of the camera 100 through the communication suit 320. The corresponding first tracking data may be generated by the tracking device 200 and transmitted to the play-back device 300.

In step S120, the controller 350 controls to generate and store recording data using the received first tracking data and to play back the second image. For example, the recording data may include second tracking data, state data and identification data for content of the virtual space.

That is, the controller 350 may record the second tracking data for tracking the movement and the state of the lens of the virtual camera VC in the virtual space based on the received first tracking data, and control the second image including the content of the virtual space linked based on the second tracking data to be played back.

In addition, while recording the second tracking data, the controller 350 may also control to record state data (i.e., timeline location, event occurrence, etc.) for the content of the virtual space at each time point of capturing. That is, the controller 350 may control to record state data related to the timeline position for the content of the virtual space at each time point of capturing. In addition, the controller 350 may control to record state data related to the event occurrence for the content of the virtual space during capturing.

Meanwhile, while recording the second tracking data, the controller 350 may control to also record identification data on the recording data. That is, the controller 350 may control to record the identification data including a time code, which is information about the time generated by the camera 100 during capturing. In addition, the controller 350 may control to record identification data including data on absolute time, which is information about the absolute time for the progress of each capturing.

In step S130, the controller 350 controls to synthesize the second image that is being played back with the received first image of the camera 100 and output the corresponding synthesized image to the second recording device 400 and the like.

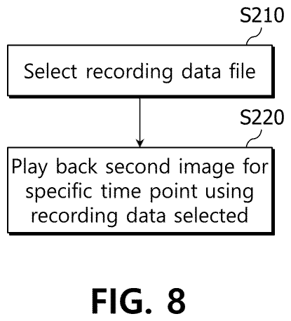

FIG. 8 shows an operation flowchart of the second control method according to an embodiment of this invention.

The second control method according to an embodiment of this invention is performed in the post-production stage after capturing, and the operation may be controlled by the controller 350 of the play-back device 300, and includes step S210 and S220 as shown in FIG. 8.

In step S210, the controller 350 controls to select a recording data file stored at the time of capturing according to a user input. For example, when it is necessary to play back the content of the virtual space at a specific time point on the basis of correction for the content of the virtual space at a specific time point in the synthesized image, the controller 350 may control to select the file in which the recording data for the specific time point is stored according to the user input. In this case, the controller 350 may control to enable a quick and accurate search for the recording data file for a specific time point by using the identification data of the recording data.

In step S220, the controller 350 controls to play back the second image for the specific time point using the selected recording data file.

That is, the controller 350 may control the movement and the lens state of the virtual camera VC in the virtual space to capture (acquire) the content of the virtual space linked to the second tracking data of the specific time point by using the second tracking data of the specific time point, thereby controlling the second image for the specific time point to be played back.

Of course, the controller 350 controls the content of the virtual space to be captured (acquired) in which state data (i.e., timeline position, event occurrence, etc.) for the content of the virtual space at a specific time point is reflected together with the corresponding second tracking data, thereby controlling the second image for the specific time point to be played back.

However, since each of the specific configurations and actions of step S110 to S130 and S210 and S220 is as described above with reference to FIGS. 1 to 6, and thus detailed descriptions thereof will be omitted below.

Each of the above-described control methods may be loaded into the memory 340 and executed by executing programs under the control of the controller 350. Such programs may be stored in the memory 340 of various types of non-transitory computer readable medium. The non-transitory computer readable medium includes tangible storage medium having various types of entities.

For example, the non-transitory computer readable media may include magnetic recording media (e.g., flexible disk, magnetic tape, and hard disk drive), magneto-optical recording media (e.g., magneto-optical disk), read only memory (CD-ROM), CD-R, CD-R/W, and semiconductor memory (e.g., mask ROM, programmable ROM (PROM), erasable PROM (EPROM), flash ROM, and random access memory (RAM)), but is not limited thereto.

In addition, the program may be supplied by various types of transitory computer readable medium. For example, the transitory computer readable medium may include electrical signals, optical signals, and electromagnetic waves, but is not limited thereto. That is, the transitory computer readable medium may supply the program to the controller 350 through wired communication routes such as electrical wires and optical fibers or wireless communication routes.

This invention configured as described above has the following characteristics.
(1) In the conventional case, only the first tracking data transmitted from the camera is simply recorded through a separate FreeD-based recording program, but substantially necessary information during playing back in the post-production stage, such as the angle of view and focus distance interpreted by the lens file, or the corrected position of the camera may not be included. On the other hand, this invention is a method of interpreting the FreeD-based first tracking data transmitted from the camera and storing the recording data including the corresponding information, and thus substantially necessary information during playing back in the post-production stages may be included in the corresponding recording data.
(2) In the conventional case, since the recording file play-back function provided by the manufacturer of the tracking device is used, raw data of the first tracking data simply recorded is sequentially read, formatted again based on FreeD, and transmitted in a UDP manner. On the other hand, the present invention stores and uses recording data of a separate format in which the second tracking data for the virtual camera and the state data for the content of the virtual space are mixed, so that when the recording data file is selected and played back in the post-production stage, the virtual camera movement, lens information, timeline position, and event occurrence are played back as they are. Accordingly, it is possible to play back the content of the virtual space again at a level very close to the state at the time of actual capturing.
(3) Difference in recording method

In this invention, the entity that records the recording data is a play-back device that executes an AR or XR program that visualizes content in an actual virtual space. Therefore, not only the final information on the virtual camera, but also all the information necessary for complete reproduction to the timeline state, the event occurrence, and the time code of the actual camera may be collected and recorded.
(4) Difference in the play-back method

In this invention, not only the second tracking data, which is simply the tracking information for the virtual camera, but also the recording data including various context information (timeline position, event occurrence history, time code, etc.) at the time of the corresponding capturing is recorded. That is, since the method of integrating and recording the information related to the content of the virtual space at the time of capturing, when the content of the corresponding virtual space need to be played back in the state at the time of capturing, it is possible to play back every moment very easily and accurately.

In addition, in the case of the conventional play-back method, when a specific recording file is play back in a FreeD-based recording program, the information is converted to FreeD and is transmitted to the XR visualization program as if the tracking device is created. That is, even at the time of play-back, the movement of the virtual camera may be played back only if there is a special XR solution that may parse the first tracking data based on FreeD and process the first tracking data through the lens file.

However, in this invention, even if there is no special XR solution at the time of play-back, the recording data file may be selected and the recording data file related to the specific time point may be extracted. The extracted recording data may be applied to the content of the virtual space without separate interpretation or processing process for the movement/lens state, timeline, and event history of the virtual camera, so that the content of the virtual space may be played back at a level similar to the site at the time of capturing.

Although the present disclosure has been described in detail with reference to specific embodiments, it is to be understood that various modifications are possible without departing from the scope of the present disclosure. Therefore, the scope of the present disclosure is not limited to the described embodiments, but should be defined by the following claims and equivalents thereto.

This invention relates to the data recording and playing back technology of a virtual production, and it is possible to provide a technology that records tracking data in image capturing based on the virtual production and uses the recorded data, thereby having industrial applicability.

What is claimed is:

1. A play-back device in a system for virtual production, which comprises a camera configured to capture a first image, which is a real image; a tracking device configured to be connected to the camera to generate and transmit first tracking data including tracking information about movement and lens state of the camera; and the play-back device configured to play back a second image including content of a virtual space based on the first tracking data, the play-back device comprising:
a memory;
a communicator configured to receive the first tracking data; and
a controller configured to control the memory to store recording data including a second tracking data comprising tracking information about the movement and the lens state of a virtual camera in the virtual space based on the first tracking data,
wherein the controller is configured to control the play-back device to play back the second image linked on the basis of the second tracking data by using the recording data.

2. The device of claim 1, wherein the controller is configured to perform synthesizing the first and second images in the virtual production simultaneously with capturing of the first and second images.

3. The device of claim 1, wherein the second tracking data corresponds to data on the movement and the lens state of the virtual camera in which the virtual camera is linked to the first tracking data at a reference position within the virtual space.

4. The device of claim 3, wherein the reference position is configured to be changeable to various positions in the virtual space during capturing.

5. The device of claim 1, wherein the movement of the virtual camera comprises information about a position and an angle of the virtual camera.

6. The device of claim 1, wherein the lens state of the virtual camera comprises information about an angle of view and focus of the lens of the virtual camera.

7. The device of claim 1, wherein the controller is configured to store state data on timeline position and event occurrence of the content of the virtual space together as the recording data.

8. The device of claim 7, wherein the content of the virtual space includes content that changes depending on the timeline position.

9. The device of claim 7, wherein the event occurrence includes an appearance, a change or a disappearance of specific content in the content of the virtual space.

10. The device of claim 7, wherein the timeline position and the event occurrence may be set to various states during capturing.

11. The device of claim 1, wherein the controller is configured to store data on a first time code generated by the camera during capturing and data on an absolute time for capturing.

12. The device of claim 11, wherein the controller is configured to control the memory to store the data on the first time code using a second time code in each frame of the first image.

13. The device of claim 11, wherein the controller is configured to control the memory to store the data of the first time code in metadata on the file of the recording data while storing the data on the absolute time together in file of the recording data.

14. The device of claim 1, wherein the controller is configured to control to synthesize the second image being played back with the first image and output a synthesized image to an external device.

15. The device of claim 14, wherein the external device includes a recording device.

16. The device of claim 1, wherein the controller is configured to control to play back the second image in the form of augmented reality (AR), virtual reality (VR), augmented reality (AR), or extended reality (XR).

17. A method performed by a play-back device in a system for virtual production, which comprises a camera configured to capture a first image, which is a real image; a tracking device configured to be connected to the camera to generate and transmit first tracking data including tracking information about movement and lens state of the camera; and the play-back device configured to play back a second image including content of a virtual space based on the first tracking data, the method comprising:
receiving the first tracking data; and
storing recording data including second tracking data comprising tracking information about the movement and the lens state of a virtual camera in the virtual space based on the first tracking data, while playing back the second image linked on the basis of the second tracking data.

18. A play-back device in a system for virtual production, which comprises a camera configured to capture a first image, which is a real image; a tracking device configured to be connected to the camera to generate and transmit first tracking data including tracking information about movement and lens state of the camera; and the play-back device configured to play back a second image including content of a virtual space based on the first tracking data, the play-back device comprising:
a memory configured to store a plurality of files of recording data including a second tracking data comprising tracking information about the movement and the lens state of the virtual camera in the virtual space; and
a controller configured to select at least one file including recording data on a specific time point at the time of capturing according to a user input,
wherein the controller is configured to control the play-back device to play back the second image for the specific time point linked based on the second tracking data by using the second tracking data of selected file, and
the second tracking data is generated using the first tracking data including tracking information about the movement and the lens state of the camera that captures the first image.
